(19) United States
(12) Patent Application Publication
(10) Pub. No.: US 2007/0217842 A1
(43) Pub. Date: Sep. 20, 2007

(54) CLEANING DEVICE, IMAGE-FORMING APPARATUS, IMAGE-FORMING PROCESS, AND PROCESS CARTRIDGE

(76) Inventors: Hiroaki Kato, Nagaokakyo-shi (JP); Hideaki Yasunaga, Osaka (JP); Masayuki Hagi, Osaka (JP); Takuya Kadota, Kobe-shi (JP); Yoshimichi Ishikawa, Itami-shi (JP); Atsushi Yamamoto, Kawanishi-shi (JP); Yoshihiro Mikuriya, Nishinomiya-shi (JP); Katsunori Kurose, Takarazuka-shi (JP); Masahide Inoue, Katsuragi-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/686,801

(22) Filed: Mar. 15, 2007

(30) Foreign Application Priority Data
Mar. 16, 2006 (JP) 2006-073405

(51) Int. Cl. G03G 21/00

(52) U.S. Cl. 399/350

(57) ABSTRACT

A cleaning device equipped with an elastic blade configured to make contact with an image bearing member to remove a toner remaining on the surface of an image bearing member, wherein the toner comprises at least a releasing agent in toner particles and at least two or more external additives of a first external additive composed of a hydrophobic silica having an average particle diameter of 5 nm to 30 nm and a second external additive composed of a hydrophobic silica having an average particle diameter of 60 nm to 300 nm, and has an average circularity of 0.880 to 0.935; the rebound elasticity modulus of an elastic material used for the elastic blade making contact with the image bearing member is 35% or more under the condition of 25° C, and the number of vibrations at the blade edge is 2.0 kHz to 4.0 kHz.

### BACKGROUND OF THE INVENTION

1. Field of the Invention

The present invention relates to a cleaning device mounted on printers, copiers, facsimiles and the like used in image forming processes.

An electrophotographic process includes a charging step, an exposing step, a developing step, a transferring step, a fixing step, and a cleaning step. In the final step of cleaning, typically, a blade-cleaning method is employed.

FIG. 1 is a view exemplarily showing a conventional electrophotographic process. With reference to FIG. 1, an image bearing member 01 is configured to be rotatably driven. First, the surface of the image bearing member 01 is uniformly charged using a charging unit 02. Next, the surface of the image bearing member 01 is exposed by irradiating the surface of the image bearing member 01 with a laser beam 03 from an optical system for exposure to form a latent electrostatic image on the image bearing member, followed by transferring a developer 05 within a developing unit 04 onto the surface of the image bearing member 01 to thereby form a visible image on the image bearing member 01.

Next, in a contact point between an intermediate transfer unit 06 and an image bearing member 01, the developer 05 on the image bearing member 01 is transferred onto the surface of the intermediate transfer unit 06 using a transfer roller 07 mounted inside the intermediate transfer unit 06 as viewed from the contact point.

The developer transferred onto the surface of the intermediate transfer unit is then transferred onto a paper sheet at a secondary transfer unit 08 and then supplied to a fixing unit 09 to thereby fix a toner image on the paper sheet.

In the meanwhile, the developer 05 remaining on the surface of the image bearing member 01 is cleaned by means of a cleaning blade 011 located in a cleaning device 010.

A blade used in blade cleaning is the one that is equipped with a plate-like elastic material such as polyurethane on a support and is configured to make contact with the surface of an electrophotographic photoconductor and pressurize the electrophotographic photoconductor surface. Therefore, to more precisely removing a residual toner on an electrophotographic photoconductor, the pressure at a contact point between a blade and an electrophotographic photoconductor should be increased. Configurations of such a contact point between a blade and an electrophotographic photoconductor are divided into a configuration in which a blade rotates in the clockwise direction relative to the rotation direction of an electrophotographic photoconductor, and a configuration in which a blade counter-rotates relative to the rotation direction of an electrophotographic photoconductor, however, from the perspective of more precisely removing a residual toner on an electrophotographic photoconductor and reducing the pressing force applied to a blade, the latter configuration, i.e., the configuration in which a blade counter-rotates relative to the rotation direction of an electrophotographic photoconductor is preferable, and virtually, most of cleaning devices employ the latter configuration.

Recently, a polymerization toner which is produced by a chemical treatment with the use of an aqueous medium, not by pulverization method which has been used conventionally, is now developed. The advantageous characteristics of such a polymerization toner are as follows. The particle diameter is uniformed, a toner is formed with higher circularity, high-quality image is more easily formed, and production costs are inexpensive.

At the same time, such a polymerization toner tends to be poor in cleaning ability and requires a greater pressing force as a matter of practice because a sufficient blocking ability to prevent a toner from passing through a cleaning blade cannot be obtained with a pressing force from an elastic blade against a surface of a photoconductor used to a toner produced by a conventional pulverization method. Accordingly, as a means to keep up a constant cleaning effect, releasing property of a toner on an electrophotographic photoconductor surface tends to be increased by reducing the friction coefficient of a toner against an electrophotographic photoconductor, and a number of methods in which a lubricant is used for a surface layer and a protective layer in an electrophotographic photoconductor have been proposed.

As lubricants, fluorine-containing resins such as polytetrafluoroethylene, resin powders such as spherically shaped acrylic resins and polyethylene resins, and metal oxide powders such as silicon oxides and aluminum oxides are known in the art. As a means to reduce the friction coefficient of a toner against photoconductor in an early stage, a method has been put to practical use in which an application mechanism is provided to apply a toner or a lubricant to vicinities of a contact point between an elastic blade and a photoconductor, and a lubricant layer is formed on the photoconductor surface.

In addition, for material of a blade used in combination, blade materials having relatively low-rebound elasticity tends to be used, aiming at preventing variations in blocking ability to prevent a toner from passing through a cleaning blade and inducing noise and chatter marks by preventing vibration caused by frictional force at a contact point with a photoconductor. Reference documents relating to the present invention are Japanese Patent Application Laid-Open (JP-A) Nos. 2004-287102, 2002-72804, and 2004-245881.

However, it is verified that for the purpose of improving releasing property of a toner at the time of fixing, a toner produced by preliminarily adding a releasing agent in a toner base material tends to have higher adhesion. Thus, a visible image is formed on a photoconductor in a developing unit, and a residual toner remaining on the photoconductor surface after transferring the toner onto a transferring unit is prevented from passing through at a contact point between a cleaning blade and the photoconductor and is hardly removed and liable to remain on a photoconductor surface. In a case of a pulverized toner having low-circularity is easily degraded in flowability and is more liable to remain on a photoconductor surface.

Accordingly, when such a residual toner amount is increased at a contact point between a cleaning blade and a photoconductor surface, problems with cleaning defects are easily caused because the pressing force of a toner occasionally exceeds the blocking ability of preventing the toner from passing through the cleaning blade, and the toner virtually passes through the contact point between the cleaning blade and the photoconductor surface.

### BRIEF SUMMARY OF THE INVENTION

The present invention is proposed in view of the present situation and aims to provide a cleaning device capable of reducing adhesion of a toner and reducing a residual toner even when an image is formed using a pulverized toner having low-circularity in a cleaning device equipped with a cleaning blade which is highly responsive and has an effect of removing a residual toner, an image forming apparatus using the cleaning device as well as an image forming process using the cleaning device.

In view of the above-mentioned shortcomings, the present inventors have investigated vigorously, have obtained the finding that the shortcomings can be eliminated by using a specific cleaning blade in combination with a specific toner, and completed the present invention.

The means to solve aforesaid problems are as follows.

<1> A cleaning device which includes an elastic blade configured to make contact with an image bearing member to remove a toner remaining on the surface of an image bearing member, wherein the toner contains at least a releasing agent in toner particles and at least two or more external additives of a first external additive composed of a hydrophobic silica having an average particle diameter of 5 nm to 30 nm and a second external additive composed of a hydrophobic silica having an average particle diameter of 60 nm to 300 nm, and has an average circularity of 0.880 to 0.935; the rebound elasticity modulus of an elastic material used for the elastic blade making contact with the image bearing member is 35% or more under the condition of 25° C., and the number of vibrations at the blade edge is 2.0 kHz to 4.0 kHz.

<2> The cleaning device according to the item <1>, wherein the static friction coefficient of the image bearing member is 0.5 to 1.0.

<3> The cleaning device according to the item <1>, wherein the elastic material used for the elastic blade has a shore A hardness of 60 to 80.

<4> The cleaning device according to the item <1>, wherein the contact angle formed when the elastic blade makes contact with the image bearing member is 7° to 20°.

<5> The cleaning device according to the item <1>, wherein the elastic blade is composed of a plate-like elastic material, and the thickness of the plate-like elastic material is 1.5 mm to 2.5 mm.

<6> The cleaning device according to the item <1>, wherein the added amount of the releasing agent in the toner is 2 parts by mass to 8 parts by mass relative to 100 parts by mass of the toner.

<7> The cleaning device according to the item <1>, wherein the exposed amount of the releasing agent on the surface of the base material in the toner determined by FTIR-ATR spectroscopy is 0.05 to 0.2.

<8> An image forming apparatus which includes a cleaning device equipped with an elastic blade configured to make contact with an image bearing member to remove a toner remaining on the surface of an image bearing member, wherein the toner contains at least a releasing agent in toner particles and at least two or more external additives of a first external additive composed of a hydrophobic silica having an average particle diameter of 5 nm to 30 nm and a second external additive composed of a hydrophobic silica having an average particle diameter of 60 nm to 300 nm, and has an average circularity of 0.880 to 0.935; the rebound elasticity modulus of an elastic material used for the elastic blade making contact with the image bearing member is 35% or more under the condition of 25° C., and the number of vibrations at the blade edge is 2.0 kHz to 4.0 kHz.

<9> The image forming apparatus according to the item <8>, wherein the static friction coefficient of the image bearing member is 0.5 to 1.0.

<10> The image forming apparatus according to the item <8>, wherein the elastic material used for the elastic blade has a shore A hardness of 60 to 80.

<11> The image forming apparatus according to the item <8>, wherein the contact angle formed when the elastic blade makes contact with the image bearing member is 7° to 20°.

<12> The image forming apparatus according to the item <8>, wherein the elastic material used for the elastic blade is formed in a plate-like shape, and the thickness of the plate-like elastic material is 1.5 mm to 2.5 mm.

<13> The image forming apparatus according to the item <8>, wherein the added amount of the releasing agent in the toner is 2 parts by mass to 8 parts by mass relative to 100 parts by mass of the toner.

<14> The image forming apparatus according to the item <8>, wherein the exposed amount of the releasing agent on the surface of the base material in the toner determined by FTIR-ATR spectroscopy is 0.05 to 0.2.

<15> An image forming process using a cleaning device equipped with an elastic blade configured to make contact with an image bearing member to clean a toner remaining on the surface of an image bearing member, wherein the toner contains at least a releasing agent in toner particles and at least two or more external additives of a first external additive composed of a hydrophobic silica having an average particle diameter of 5 nm to 30 nm and a second external additive composed of a hydrophobic silica having an average particle diameter of 60 nm to 300 nm, and has an average circularity of 0.880 to 0.935; the rebound elasticity modulus of an elastic material used for the elastic blade making contact with the image bearing member is 35% or more under the condition of 25° C., and the number of vibrations at the blade edge is 2.0 kHz to 4.0 kHz.

<16> The image forming process according to the item <15>, wherein the static friction coefficient of the image bearing member is 0.5 to 1.0.

<17> The image forming process according to the item <15>, wherein the elastic material used for the elastic blade has a shore A hardness of 60 to 80.

<18> The image forming process according to the item <15>, wherein the contact angle formed when the elastic blade makes contact with the image bearing member is 7° to 20°.

<19> The image forming process according to the item <15>, wherein the elastic material used for the elastic blade is formed in a plate-like shape, and the thickness of the plate-like elastic material is 1.5 mm to 2.5 mm.

<20> The image forming process according to the item <15>, wherein the added amount of the releasing agent in the toner is 2 parts by mass to 8 parts by mass relative to 100 parts by mass of the toner.

<21> The image forming process according to the item <15>, wherein the exposed amount of the releasing agent on the surface of the base material in the toner determined by FTIR-ATR spectroscopy is 0.05 to 0.2.

<22> The image forming apparatus according to the item <8> being any one of a printer, a copier, and a facsimile.

<23> A process cartridge which can be detachably mounted on a body of an image forming apparatus which includes at least one selected from an image bearing member, a cleaning unit, a charging unit, an exposing unit, and a developing unit assembled in an integral unit, wherein the cleaning unit is a cleaning device which includes an elastic blade configured to make contact with an image bearing member to remove a toner remaining on the surface of an image bearing member; the toner contains at least a releasing agent in toner particles and at least two or more external additives of a first external additive composed of a hydrophobic silica having an average particle diameter of 5 nm to 30 nm and a second external additive composed of a hydrophobic silica having an average particle diameter of 60 nm to 300 nm, and has an average circularity of 0.880 to 0.935; the rebound elasticity modulus of an elastic material used for the elastic blade making contact with the image bearing member is 35% or more under the condition of 25° C., and the number of vibrations at the blade edge is 2.0 kHz to 4.0 kHz.

According to the present invention, it is possible to provide a cleaning device allowing for obtaining more highly responsiveness and enhancement of an effect of removing a residual toner by obtaining high-rebound elasticity in vibration behavior at a contact point between an elastic blade and a photoconductor and further allowing for reduction in toner adhesion and a residual toner amount by using a toner containing an external additive having a large diameter and an external additive having a small diameter, an image forming apparatus, an image forming process, and a process cartridge.

### BRIEF DESCRIPTION OF THE SEVERAL VIEWS OF THE DRAWINGS

FIG. 1 is a view schematically illustrating a conventional electrophotographic process.

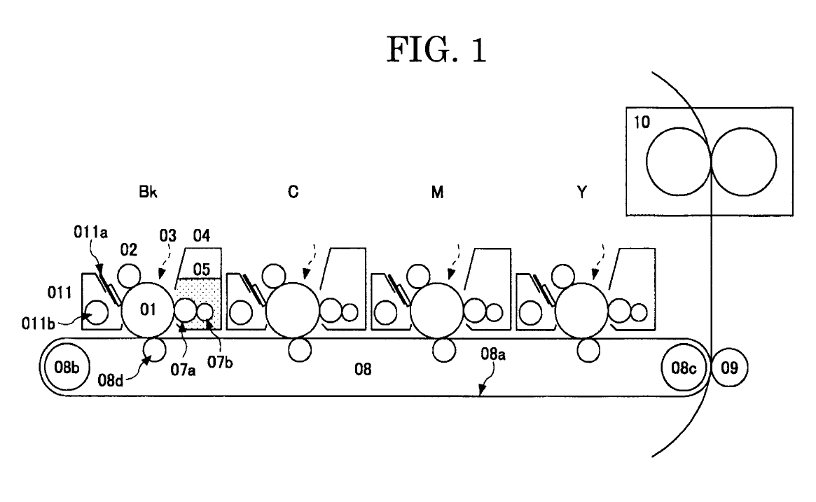

FIG. 2 is a view schematically showing a cleaning device according to the present invention.

FIG. 3 is a detailed view of the cleaning device shown in FIG. 2.

FIG. 4 is a graph showing effects of preventing occurrences of cleaning defects based on the relation between the rebound elasticity of an elastic blade of the present invention and the surface friction coefficient of a photoconductor.

### DETAILED DESCRIPTION OF THE INVENTION

Hereinafter, the present invention will be described in detail with reference to attached figures.

(Cleaning Device)

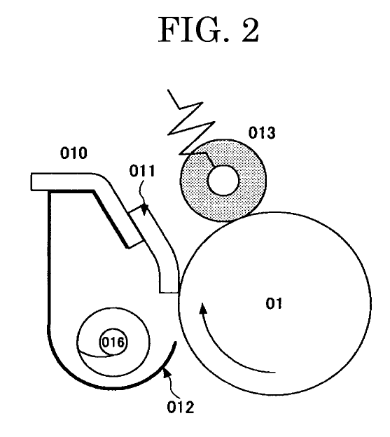

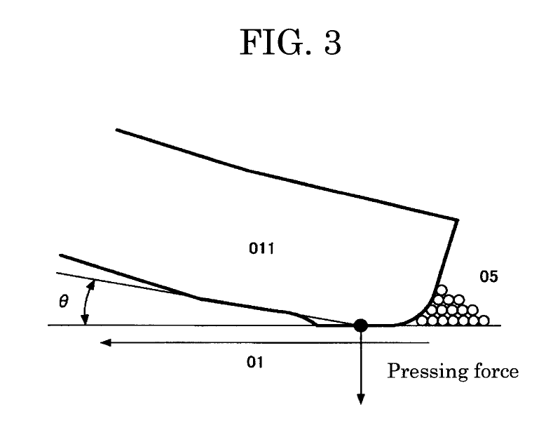

FIG. 2 shows an example of a cleaning device of the present invention. FIG. 3 is a detailed view of the cleaning device shown in FIG. 2. In FIG. 2, a cleaning device used for removing a toner adhered on the surface of an image bearing member 1 is equipped with a toner collecting case 12, a cleaning blade unit (10 and 11), and a screw 16 for transferring a collected toner. The cleaning blade unit is composed of a plate-like elastic blade 11 and a support member 10 for supporting the elastic blade 11, and the elastic blade 11 is pressure connected to the surface of the image bearing member 1 with a constant pressure. In FIG. 3, the elastic blade 11 is used in a pressure contact condition with a given angle θ is formed between the elastic blade 11 and the surface of the image bearing member 1 rotating in the direction indicated by the arrow by means of a bias unit such as a spring to thereby hold a residual toner 5 back. Specifically, the given angle 0 represents an angle formed between the photoconductor tangential direction and the cleaning blade in the vicinity of the contact point, and generally, the angle θ is a value smaller than the designed angle. The given angle θ is typically used in the range of 7° to 20°, though, depending on the used cleaning system. More preferably, the given angle 0 is used in the range of 10° to 15° to increase the effect induced by behavior of the elastic blade 11 at the contact point with the surface of the image bearing member 1. When the angle θ is wider than 20°, the contact condition between the cleaning blade 11 and the image bearing member 1, stick-slip phenomena and chatter marks occur, resulting in frequent occurrences of cleaning defects.

[Resilient Blade]

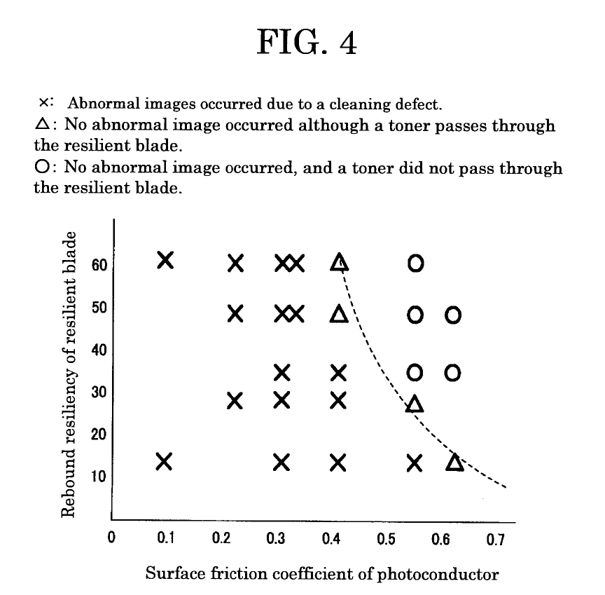

For material used for the elastic blade, it is possible to suitably select one from thermoplastic resins such as resins commonly used for conventional blade members such as urethane resins, styrene resins, olefin resins, vinylchloride resins, polyester resins, polyamide resins, and fluorine resins. Of these, a polyurethane rubber is particularly preferably used. A polyurethane rubber can be produced by using a polyol and a polyisocyanate to prepare a urethane prepolymer, adding a curing agent in the urethane prepolymer, pouring the mixture in a die, subjecting the mixture to a crosslinking reaction to be hardened, followed by aging it at room temperature. For the physical properties of the elastic blade of the present invention, an elastic blade having a shore A hardness ranging from 60 to 80, an elongation rate ranging from 1.0% to 5.0%, and 300 percent modulus ranging from 100 kg/cm² to kg/cm² is preferably used. In particular, favorable cleaning results are demonstrated in FIG. 4 with a rebound elasticity modulus of 35% or more. More favorable responsiveness and more favorable toner removing effect can be obtained by increasing the rebound elasticity of the elastic blade in behavior induced by vibrations at the contact point between the elastic blade and the photoconductor. Summarizing above, in the present invention, an elastic blade having a degree of rebound elasticity of 35% is used in consideration of noise generated by vibrations of the elastic blade under a high temperature and high humidity environment.

Material of the elastic blade of the present invention is not particularly limited and may be suitably selected from among commercially available elastic materials, however, polyurethane is particularly preferable.

The hardness of the elastic blade is measured under the condition of a temperature of 24° C. and a relative humidity of 50% according to the method described in JIS K6253, and the rebound elasticity modulus of the elastic blade is measured under the condition of a temperature of 24° C. and a relative humidity of 50% according to the method described in JIS K6301.

The elastic blade is affixed to a support member and then arranged in a cleaning device. Material of the support member is not particularly limited, however, metal, plastic, ceramics and the like can be used. Since a certain degree of strength is applied to the support member, a metal plate is preferably used for the support member, and a steel plate, an aluminum plate, or a phosphor-bronze plate etc. is particularly preferably used.

The elastic blade is formed in such a shape that can be used as a cleaning blade for an image bearing member of a cleaning device to be generally incorporated into an image forming apparatus. The entire shape of the elastic blade is not particularly limited as long as it is formed in a so-called blade shape of which the edge of the elastic blade makes contact with an image bearing member. Generally, the thickness of the elastic blade is selected from 1.5 mm to 2.5 mm. When the thickness of the elastic blade is thinner than 1.5, constant vibrations cannot be obtained, and cleaning defects occur because a residual toner slips through the elastic blade. When the thickness of the cleaning blade is thicker than 2.5 mm, noise is generated from the cleaning blade.

[Static Friction Coefficient of Photoconductor]

In a photoconductor, to eliminate an accumulated residual toner by activating behavior at a contact point between the elastic blade and the photoconductor, the photoconductor is provided with a surface property that can easily produce vibrations at the contact point of the elastic blade. In other words, the static friction coefficient of the photoconductor is increased to accelerate the vibration by means of a frictional force at the contact point of the elastic blade.

The static friction coefficient of the photoconductor of the present invention was calculated by Euler belt method and was calculated as follows.

A photoconductor for measurement is held on a pedestal, and a sheet of high-quality paper (Type 6200 manufactured by Ricoh Company Ltd.) cut in 30 mm in width and 297 mm in length is placed as a belt on the photoconductor. A weight of 100 g is attached to one end of the belt, and another end of the belt is fixed to a digital force gauge. The digital force gauge is moved at a constant speed, and the static friction coefficient of the photoconductor was calculated from the following equation based on the load at the movement start time.
μS=2/π×In (F/W)

In the equation, “μS” represents a static friction coefficient, F represents a load, W represents a weight of the weight, and “π” represents the ratio of the circumference of the circle to the diameter of the photoconductor.

It was verified that the amount of a residual toner accumulated in the vicinity of a contact point of the elastic blade was significantly reduced and an effect of suppressing occurrence of cleaning defects was also enhanced as shown in FIG. 4. However, the static friction coefficient of the photoconductor surface is more than 1.0, stick-slip phenomenon and so-called charter marks occurs due to a too high-frictional force of the photoconductor with the image bearing member, resulting in frequent occurrences of cleaning defects. Accordingly, in the present invention, the static friction coefficient of the photoconductor surface is preferably set in the range of 0.5 to 1.0, and it is more preferable to use a photoconductor having a static friction coefficient of 0.6.

[Number of vibrations at Blade Edge]

The number of vibrations of the blade edge was measured using a strain gauge (KFC-5-120-C1-11-L3M2R manufactured by Kyowa Electric Co., Ltd.). Specifically, the number of vibrations of the blade edge of 0.5 mm above the tip of the blade in the central part. When the number of vibrations is 2.0 kHz or less, vibrations are not produced at the contact point that the blade makes contact with the photoconductor surface, and a toner is likely to accumulate to cause cleaning defects. When the number of vibrations is 4 kHz or more, the elastic blade loses touch with the photoconductor surface to cause cleaning defects.

(Toner)

For a toner preferably used in the present invention, the volume average particle diameter of the toner is preferably 9.0 μm or less when measured using MULTISIZER III manufactured by Beckman Coulter Co. in consideration of affect on image quality, and thus a toner having a volume average particle diameter of 8 μm was used. A releasing agent was added in a toner base material to maintain and improve separation performance between paper and a fixing unit when a toner image formed on a transferring sheet paper was fixed.

Toner particles constituting a toner for forming full-color images in the present invention preferably contains a first binder resin which will be hereinafter described, a second binder resin, a colorant, a charge controlling agent, and external additives.

[Binder Resin]

The first binder resin and the second binder resin are not particularly limited and may be suitably selected from among binder resins known in the art of full-color toner. Examples of the binder resins include polyester resins, (meth)acrylic resins, styrene-(meth)acrylic copolymer resins, epoxy resins, and COC (cyclic olefin copolymer resins) such as TOPAS-COC (manufactured by Ticona GMBH). However, from the perspective of oil-less fixing performance, it is preferable to use polyester resins for both the first binder resin and the second binder resin.

For the polyester resins preferably used in the present invention, it is possible to use a polyester resin prepared by a polycondensation reaction between a polyvalent alcohol component and a polyvalent carboxylic acid component. Examples of divalent alcohol components among the polyvalent alcohol components include bisphenol A alkylene oxide adducts such as polyoxypropylene (2,2)-2,2-bis(4-hydroxyphenyl)propane, polyoxypropylene (3,3)-2,2-bis(4-hydroxyphenyl)propane, polyoxypropylene(6)-2,2-bis(4-hydroxyphenyl)propane, and polyoxyethylene (2,0)-2,2-bis(4-hydroxyphenyl)propane; ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polytetramethylene glycol, bisphenol A, and hydrogenated bisphenol A. Examples of trivalent alcohol components among polyvalent alcohol components include sorbitol, 1,2,3,6-hexane tetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Examples of divalent carboxylic acid components among the polyvalent carboxylic acid components include maleic acids, fumaric acids, citraconic acids, itaconic acids, glutaconic acids, phthalic acids, isophthalic acids, terephthalic acids, cyclohexane dicarboxylic acids, succinic acids, adipic acids, sebacic acids, azelaic acids, malonic acids, n-dodecenyl succinic acids, isododecenyl succinic acids, n-dodecyl succinic acids, isododecyl succinic acids, n-octenyl succinic acids, isooctyl succinic acids, and anhydrides or lower alkyl esters of the acids thereof.

Examples of trivalent or more carboxylic acid components among the polyvalent carboxylic acid components include 1,2,4-benzenetricarboxylic acid (trimellitic acid), 1,2,5-benzenetricarboxylic acid, 2,5,7-naphthalenetricarboxylic acid, 1,2-4-naphthalenetricarboxylic acid, 1,2,4-butanetricarboxylic acid, 1,2,5-hexanetricarboxylic acid, 1,3-dicarboxyl-2-methyl-2-methylene carboxy propane, 1,2,4-cyclohexanetricarboxylic acid, tetra(methylene carboxyl)methane, 1,2,7,8-octanetetracarboxylic acid, pyromellitic acids, empole trimer acid, and anhydrides or lower alkyl esters of the acids thereof.

In the present invention, for the polyester resin, a resin that can be obtained by the following method is preferably used. Specifically, a mixture of a raw material monomer composed of a polyester resin, a raw material monomer composed of a vinyl resin, and a monomer capable of reacting with both of the resin raw material monomers is used. The mixture is subjected to a polycondensation reaction to yield a polyester resin in parallel with a radical polymerization reaction to yield a vinyl resin in the same vessel to thereby prepare a resin. The resin (hereinafter, may be referred to as “vinyl polyester resin”) can be preferably used. The monomer capable of reacting with both of the resin raw material monomers means a monomer capable of reacting in both the polycondensation reaction and the radical polymerization reaction. In other words, the monomer is a monomer having a polycondensable carboxy group and a radically polymerizable vinyl group, and examples thereof include fumaric acids, maleic acids, acrylic acids, and methacrylic acids.

Examples of the raw material monomer composed of a polyester resin include the polyvalent alcohol components and polyvalent carboxylic acid components set forth above. Examples of the raw material monomer composed of a vinyl resin include styrene or derivatives thereof such as styrene, o-methylstyrene, m-methylstyrene, p-methylstyrene, α-methylstyrene, p-ethylstyrene, 2,4-dimethylstyrene, p-tert-butylstyrene, and p-chlorostyrene; ethylene unsaturated monoolefines such as ethylene, propylene, butylene, and isobutylene; methacrylic acid alkyl esters such as methyl methacrylate, n-propyl methacrylate, isopropyl methacrylate, n-butyl methacrylate, isobutyl methacrylate, t-butyl methacrylate, 3-(methyl)butyl methacrylate, hexyl methacrylate, octyl methacrylate, nonyl methacrylate, decyl methacrylate, undecyl methacrylate, and dodecyl methacrylate; alkylester acrylates such as methyl acrylate, n-propyl acrylate, isopropyl acrylate, n-butyl acrylate, isobutyl acrylate, t-butyl acrylate, n-pentyl acrylate, isopentyl acrylate, neopentyl acrylate, 3-(methyl)butyl acrylate, hexyl acrylate, octyl acrylate, nonyl acrylate, decyl acrylate, undecyl acrylate, and dodecyl acrylate; unsaturated carboxylic acids such as acrylic acids, methacrylic acids, itaconic acid, and maleic acid; acrylonitrile, ester maleate, ester itaconate, vinyl chloride, vinyl acetate, vinyl benzoate, vinylmethylethylketone, vinylhexylketone, vinylmethylether, vinylethylether, and vinylisobutylether. Examples of a polymerization initiator used when the raw material monomer composed of a vinyl resin is polymerized include azo compounds or diazo compounds such as 2,2′-azobis(2,4-dimethylvaleronitrile), 2,2′-azobisisobutylonitrile, 2,2′-azobisisobutylonitrile, 1,1′-azobis(cyclohexane-1-carbonitrile), and 2,2′-azobis-4-methoxy-2,4-dimethylvaleronitrile; and peroxide-based polymerization initiators such as benzoyl peroxides, dicumyl peroxides, methylethylketone peroxides, isopropyl peroxide carbonates, and lauroyl peroxides.

For the first binder resin and the second binder resin, the various polyester resins as described above are preferably used. Among these, from the perspective of further improving separation performance and offset resistance for a toner for oil-less fixing, the first binder resin and the second binder resin described below are preferably used.

A more preferable first binder resin is a polyester resin that can be obtained by subjecting the polyvalent alcohol component and the polyvalent carboxylic acid component to a polycondensation reaction. A particularly preferable first binder resin is a polyester resin that can be obtained by using a bisphenol A alkylene oxide adduct as the polyvalent alcohol component, and using a terephthalic acid and a fumaric acid as the polyvalent carboxylic acid component.

A more preferable second binder resin is a vinyl-based polyester resin. A particularly preferable vinyl-based polyester resin is a vinyl-based polyester resin that can be obtained by using a bisphenol A alkylene oxide adduct, a terephthalic acid, a trimellitic acid, and a succinic acid as the raw material monomer composed of a polyester resin, and using a styrene and a butyl acrylate as the raw material monomer composed of a vinyl-based resin.

In the present invention, a hydrocarbon wax is internally added in the first binder resin when the first binder resin is synthesized. To internally add a hydrocarbon wax in the first binder resin beforehand, it only requires that the first binder resin be synthesized in a state where a hydrocarbon-based wax is added in a monomer used for synthesizing the first binder resin. For example, in a state where a hydrocarbon wax is added to an acid monomer and an alcohol monomer constituting a polyester resin as the first binder resin, the materials are subjected to a polycondensation reaction. When the first binder resin is a vinyl-based polyester resin, the raw material monomer composed of a vinyl-based resin is delivered by drops to the polyester resin monomer in a state where a hydrocarbon-based wax is added in the polyester resin monomer while stirring and heating the polyester resin monomer to thereby subject the monomers to a polycondensation reaction and a radical polymerization reaction.

[Wax]

Typically, when a wax having a lower polarity than that of the first binder resin is used, the toner is excellent in the releasing property to fixing rollers. The wax used in the present invention is a hydrocarbon-based wax having a lower polarity.

The hydrocarbon-based wax is a wax containing only carbon atoms and hydrogen atoms and containing no ester group, alcohol group, amide group, and the like. Specific examples of the hydrocarbon-based wax include polyolefin waxes such as polyethylene, polypropylene, and copolymers between ethylene and propylene; petroleum waxes such as paraffin wax, and microcrystalline wax; and synthetic waxes such as Fischertropsch wax. Of these, polyethylene waxes, paraffin waxes, Fischertropsch waxes are preferably used, and polyethylene wax and paraffin wax are more preferably used in the present invention.

[Wax Dispersing Agent]

In the toner used in the present invention, a wax dispersing agent may be added to help dispersion of the wax.

The wax dispersing agent is not particularly limited and may be suitably selected from among those known in the art. Examples thereof include polymers or oligomers in which a unit which is highly soluble in the wax and a unit which is highly soluble in the resin reside as a block compound; polymers or oligomers in which any one of a unit which is highly soluble in the wax and a unit which is highly soluble in the resin is grafted to the other unit; copolymers between an unsaturated hydrocarbon such as ethylene, propylene, butane, and α-styrene and α,β-unsaturated carboxylic acid such as acrylic acid, methacrylic acid, maleic acid, maleic acid anhydride, itaconic acid, and itaconic acid anhydride, and esters or anhydrides thereof; block compounds or graft compounds prepared between a vinyl resin and a polyester.

Examples of the unit which is highly soluble in the wax include long chain alkyl groups each having 12 or more carbon atoms, polyethylenes, polypropylenes, polybutenes, polybutadienes, and copolymers thereof. Examples of the unit which is highly soluble in the resin include polyesters, and vinyl resins.

[Charge Controlling Agent]

The charge controlling agent may be suitably selected from among those known in the art, and examples thereof include nigrosine dyes, triphenylmethane dyes, chrome-containing metal complex dyes, molybdenum acid chelate pigments, Rhodamine dyes, alkoxy amines, quaternary ammonium salts (including fluorine-modified quaternary ammonium salts), alkylamine, monomers or compounds of phosphorous, monomers or compounds of tungsten, fluorochemical surfactants, salicylic acid metal salts, and metal salts of salicylic aid derivatives. Specific examples thereof include BONTRON 03 (nigrosine dye), BONTRON P-51 (quaternary ammonium salt), BONTRON S-34 (metal azo-containing dye), E-82 (oxynaphthoic acid-based metal complex), E-84 (salicylic acid-based metal complex), E-89 (phenol condensate) (all manufactured by Orient Chemical Industries, Ltd.); TP-302 and TP-415 (quaternary ammonium salt molybdenum complex (all manufactured by Hodogaya Chemical Co.); COPY CHARGE PSY and VP 2038 (quaternary ammonium salt), COPY BLUE PR (triphenylmethane derivative), COPY CHARGE NEG VP2036 (quaternary ammonium salt), COPY CHARGE NX VP434 (all manufactured by Hochst Corporation); LRA-901, LR-147 (boron complex) (all manufactured by Japan Carlit Co., Ltd.); and polymer-based compounds each having a functional group such as copper phthalocyanine, perylene, quinacridone, azo pigments, other sulfonic acid groups, carboxyl groups, and quaternary ammonium salts. Of these, a material that controls the toner to have a negative polarity is particularly preferably used.

The added amount of the charge controlling agent is determined depending on the type of binder resin, presence or absence of additives used in accordance with the necessity, and the method of producing the toner including a dispersion method and cannot be uniformly determined, however, typically, the charge controlling agent is used in a range of 0.1 parts by weight to 10 parts by weight relative to 100 parts by weight of the binder resin. Preferably, the added amount of the charge controlling agent is used in a range of 0.2 parts by weight to 5 parts by weight. When the added amount of the charge controlling agent is more than 10 parts by weight, the effect of the charge controlling agent is reduced due to excessive chargeability of the toner, and the static suction force to developing rollers is increased to possibly cause degradation of flowability of the used developer and degradation of image density.

[Colorant]

The colorant used in the toner of the present invention may be suitably selected from among those known in the art.

Examples thereof include carbon black, nigrosine dye, iron black, naphthol yellow S, Hansa yellow (10G, 5G, and G), cadmium yellow, yellow iron oxide, yellow ocher, yellow lead, titanium yellow, polyazo yellow, oil yellow, Hansa yellow (GR, A, RN, R), pigment yellow L, benzidine yellow (G, GR), permanent yellow (NCG), vulcan fast yellow (5G, R), tartrazinelake yellow, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL, F4RH), fast scarlet VD, vulcan fast rubin B, brilliant scarlet G, lithol rubin GX, permanent red F5R, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS, BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian green, emerald green, pigment green B, naphthol green B, green gold, acid green lake, malachite green lake, phthalocyanine green, anthraquinon green, titanium oxide, zinc flower, lithopone, and mixtures thereof.

In the present invention, the content of the colorant is typically 1% by weight to 15% by weight relative to the toner and preferably 3% by weight to 10% by weight relative to the toner.

[Preparation of Colorant Masterbatch]

The colorant used in the present invention may be combined with the resin to use it as a masterbatch.

Examples of a binder resin used in preparation of the masterbatch or kneaded together with the masterbatch include, besides the polyesters and vinyl-based resins set forth above, rosins, modified rosins, terpene resins, aliphatic or alicyclic hydrocarbon resins, aromatic petroleum resins, chlorinated paraffin, and paraffin waxes. Each of these may be used alone or in combination with two or more.

[External Additive]

In the present invention, at least two external additives are used, and it is preferable that a hydrophobic silica having an average particle diameter of 5 nm to 30 nm is used as a first external additive, and a hydrophobic silica having an average particle diameter of 60 nm to 300 nm is used as a second external additive.

[First External Additive]

In the toner of the present invention, when the first external additive has an average particle diameter of 30 nm or more, predetermined flowability cannot be obtained to degrade handleability, heat resistant storage stability is degraded, and problems with toner-fixing and toner-packing in a developing unit may occur.

[Second External Additive]

In the toner of the present invention, the adhesive force between toner particles can be reduced to alleviate a compacted state to thereby prevent accumulation of the toner on the cleaning blade by using a hydrophobic silica having an average particle diameter of 60 nm or more as the second external additive. However, when the average particle diameter of the second external additive is more than 300 nm, it is unfavorable because a large amount of components is released in the external additive to possibly induce toner-filming to an image bearing member.

[Amount of Wax/Amount of Wax on Toner Surface]

In the toner of the present invention, the added amount of the releasing agent in the toner base material is preferably 2 parts by mass to 8 parts by mass relative to 100 parts by mass of the toner for the purpose of improving the fixing property and isolation property of the toner. In such a case, for the amount of releasing agent residing in the vicinity of the surface of the toner base material, a toner containing a releasing agent in an amount ranging from 0.05 to 0.2 determined by FTIR-ATR spectroscopy was used.

The analyzable depth of a toner particle is about 0.3 μm from the surface of the toner particle based on the FTIR-ATR principle. Based on the analysis, a relative amount of the wax residing in the area of 0.3 μm in depth from the surfaces of the toner particles can be determined. The depth measurement method is as follows.

First, as a sample, a pellet having a thickness of 40 mmφ (about 2 mm) was prepared by pressing 3 g of the toner under a load of 6t for 1 minute using an automatic pellet formation device (Type M No. 50 BRP-E manufactured by MAEKAWA TESTING MACHINE CO.). The surface of the toner pellet was measured by FTIR-ATR method. The used microscope FTIR imaging device was Spectrum One manufactured by Perkin Elmer equipped with a MultiScope FTIR unit, and the surface of the toner pellet was measured utilizing the micro ATR of a germanium (Ge) crystal having a diameter of 100 μm with an incident angle of 41.5° and resolution of 4 cm⁻¹ at 20 times of integration.

In the measurement, the binder resin used as the base, and various materials such as releasing agent and the like to be measured can be identified, and it is necessary to select a non-overlapped wavelength. A peak Pwax derived from the releasing agent and a peak Presin derived from the binder resin were selected, and an analytical curve relating to a strength ratio (Pwax/Presin) and a content of the releasing agent was preliminarily prepared. A relative volume content of the releasing agent residing in the vicinity of toner particle surfaces was determined based on the strength ratio (Pwax/Presin). The sample was measured as to the volume content of the releasing agent 4 times at different measurement sites, and the average value was used.

In such a toner, there is a tendency that most of a residual toner held back at a contact point between an elastic blade and the surface of a photoconductor cannot be removed to accumulates in a space in the vicinity of the contact point with a method in which the elastic blade makes contact with the photoconductor surface in a toner leaning device used for removing a residual toner remaining on a photoconductor after developing an image on the photoconductor surface and transferring the image on a sheet paper.

Particularly when the average circularity of such a toner is reduced to 0.880 to 0.935 (measured using FPIA 2100 manufactured by SYSMEX CORPORATION), it is verified that the deposition of such a residual toner tends to be prominent, and part of the residual toner passes through the contact point of the elastic blade due to an increased pressing force of the toner in the long-term use to cause cleaning defects such as contamination of a charging unit and noise occurrence on formed images.

For the method of measuring the toner shape, it is appropriate to employ an optically detecting method in which a suspension containing toner particles is made to pass through an imaging portion detecting part on a plain plate, and an image of the toner particles is optically detected by means of a CCD camera and analyzed.

A value that the circumferential length of a circle whose area is equal to the projected area obtained by the above-noted method divided by the circumferential length of the actually used toner particle is a value measured as the average circularity using a flow particle image analyzer, FPIA-2000.

The method of measuring the average circularity of toner particles is described in detail below.

In a vessel, 100 mL to 150 mL of water of which impurities has been removed beforehand is poured, 0.1 mL to 0.5 mL of a surfactant, preferably an alkylbenzene sulfonate is added as a dispersing agent, and about 0.1 g to 0.5 g of a measurement sample is further added thereto. The suspension with the sample dispersed therein is subjected to a dispersion treatment for about 1 minute to 3 minutes in an ultrasonic dispersion device to set the concentration of the dispersion to 3,000/μL to 10,000/μL, and then the shape and the particle distribution of the toner are measured using the above-noted device, thereby the average circularity can be obtained.

Even when an image is formed with the use of such a pulverized toner having a lower circularity, the toner adhesive force and a residual toner amount can be reduced in the image formation according to the present invention. Thus, in the present invention, a toner containing at least a releasing agent in a toner base material and at least two external additives is used. When the toner has a hydrophobic silica having an average particle diameter of 5 nm to 30 nm as a first external additive and a hydrophobic silica having an average particle diameter of 60 nm to 300 nm as a second external additive, and the average circularly of the toner is 0.880 to 0.935, the rebound elasticity modulus of an elastic material used for the elastic blade which makes contact with an image bearing member is 35% or more at a temperature of 25° C., and the number of vibrations at the blade edge is 2.0 kHz to 4.0 kHz. In the present invention, a cleaning device is used in which a plate-like elastic blade for removing a residual toner remaining on an image bearing member is arranged. In such an image forming process, the responsiveness of the cleaning blade is favorable, and more favorable scraping-out effect can be achieved. Further, in the present invention, even with a pulverized toner having a low circularity, it is possible to achieve image formation while reducing a toner adhesive force and reducing a residual toner amount.

Thus, the image forming process of the present invention is not limited, provided that it is an image forming process using the above-noted cleaning device under the conditions of a toner described above. The cleaning device of the present invention is preferably used for and mounted to, for example, image forming apparatuses such as printers, copiers, and facsimiles to eliminate cleaning defects.

The cleaning device of the present invention is excellent in space-saving because it employs blade cleaning system, and it is preferable to be configured to detachably mounted to a body of an image forming apparatus.

### EXAMPLES

Hereinafter, the present invention will be further described in detail referring to specific Examples and Comparative Examples, however, the present invention is not limited to the disclosed Examples.

First, the method of producing a toner according to the present invention will be described below.

[Preparation of First Binder Resin]

In a dropping funnel, as a vinyl-based monomer, 600 g of styrene, hog of butyl acrylate, 30 g of acrylic acid, and as a polymerization initiator, 30 g of dicumyl peroxide were poured. In a four-aperture flask equipped with a thermometer, a stainless-steel stirrer, a flow-down condenser, and a nitrogen inlet tube, among a polyester monomer, as a polyol, 1,230 g of polyoxypropylene (2,2)-2,2-bis(4-hydroxyphenyl)propane, 290 g of polyoxyethylene (2,2)-2,2-bis(4-hydroxyphenyl)propane, 250 g of isododecenyl succinic anhydride, 310 g of terephthalic acid, 180 g of 1,2,4-benzenetricarboxylic anhydride, as an esterified catalyst, 7 g of dibutyltin oxide, and as a wax, 340 g of paraffin wax (11.0 parts by weight relative to 100 parts by weight of the impregnated monomer) (melting point: 73.3° C., half width of endothermic peak measured with a differential scanning calorimeter when raising the temperature: 4° C.) were poured, the mixture was stirred at a temperature of 160° C. in a mantle heater under a nitrogen atmosphere, and then the mixture of the vinyl-based monomer and the polymerization initiator was delivered by drops into the mixture of polyester monomer through a dropping funnel in 1 hour. The mixture of the vinyl-based monomer and polyester monomer was subjected to an addition polymerization reaction for 2 hours while keeping the temperature at 160° C. and aged, and then the temperature of the mixture was raised to 230° C. to subject the mixture to a polycondensation reaction. The polymerization degree of the monomer mixture was traced with the softening point measured using a constant load extruded capillary rheometer, and the polycondensation reaction was completed when the temperature reached a desired softening point to thereby obtain a resin H1. The resin H1 had a softening point of 130° C.

[Preparation of Second Binder Resin]

In a four-aperture flask equipped with a thermometer, a stainless-steel stirrer, a flow-down condenser, and a nitrogen inlet tube, as a polyol, 2,210 g of polyoxypropylene (2,2)-2,2-bis(4-hydroxyphenyl) propane, 850 g of terephthalic acid, 120 g of 1,2,4-benzentricarboxylic acid anhydride, and as an esterified catalyst, 0.5 g of dibutyltin oxide were poured, and the temperature of the mixture was raised to 230° C. in a mantle heater under a nitrogen atmosphere to subject the mixture to a polycondensation reaction. The polymerization degree of the monomer mixture was traced with the softening point measured using a constant load extruded capillary rheometer, and the polycondensation reaction was completed when the temperature reached a desired softening point to thereby obtain a resin L1. The resin L1 had a softening point of 115° C.

[Preparation of Toner Particles]

A masterbatch containing 4 parts by mass of C.I. Pigment Read 57-1 relative to 100 parts by mass of the binder resin composed of the first and the second binder resins (including the weight of an internally added wax) was sufficiently mixed in HENSCHEL MIXER, and the mixture was melted and kneaded by using a biaxial extrusion kneader (PCM-30 manufactured by IKEGAI LTD.). The obtained kneaded binder was rolled to a sheet of 2 mm in thickness using a cooling press roller, cooled using a cooling belt, and then coarsely pulverized in FEATHER MILL. Thereafter, the coarsely pulverized binder was pulverized using a mechanical pulverizer (KTM manufactured by KAWASAKI HEAVY INDUSTRIES, LTD.) so as to have an average particle diameter of 10 μm to 12 μm and then further pulverized while roughly classifying the binder using a jet pulverizer (IDS, manufactured by Nippon Pneumatic Manufacturing Co., Ltd.), followed by classification of the fine resin powder using a rotor classifier (T-PLEX type classifier, 100 ATP manufactured by Hosokawa micron Co., Ltd.) to thereby obtain a colored resin particle 1. The particle diameter of the colored resin particle was 7.5 μm. The weight ratio (H1/L1) between the first binder resin H1 and the second binder resin L1 is preferably 20/80 to 72/28 from the perspective of the wax content. When the weight ratio (H1/L1) is smaller than 20/80, a desired wax amount cannot be obtained, and a sufficient releasing effect cannot be obtained at the fixing unit to make a paper sheet wind itself around the fixing roller. In contrast, the weight ratio is greater than 72/28, the wax is released from the toner in the vicinity of the photoconductor and the developing unit to fix on a controlling blade unit and the photoconductor surface. In the embodiments of the present invention, a toner having a weight ration of 40/60 (H1/L1) was used.

A desired amount (part by mass) of an inorganic fine particle was added to 1,100 parts by mass of the colored resin particle, and these particles were mixed in HENSCHEL MIXER to yield a magenta toner.

In the embodiments of the present invention, the amount of the wax on the toner surface was 0.127. When the amount of the wax on the toner surface is less than 0.050, a sufficient releasing effect cannot be obtained in the fixing unit to make a paper sheet wind itself around the fixing roller. When the amount of the wax on the toner surface is more than 0.200, the wax readily released from the toner surface, and the toner adhesive force is increased to make the toner fix on a controlling blade unit and the photoconductor surface.

[Resilient Blade]

For the elastic blade, a blade composed of a polyurethane elastomer with rebound elasticity imparted thereto (manufactured by Hokushin Corporation) shown in Table 1 was used. The basic physical properties of the blade are as follows.

| Hardness: | 70 shore A (JIS-A) | |
|---|---|---|
| Young's modulus: | 66 | kg/cm² |
| 300% modulus: | 123 | kg/cm² |
| Tensile strength: | 300 | kg/cm² |

[Evaluation on Cleaning Defect]

To check cleaning defects, toner smear on the surface of a charge roller arranged to make contact with a photoconductor in the downstream of a contact point between the elastic blade used in the Examples and the photoconductor was collected with a tape after outputting given sheets of paper (in the embodiments of the present invention, based on image smear after outputting 1,000 sheets of a 5% image-area ratio chart), and toner smear adhered on the tape was visually checked or the concentration of the toner smear was measured to evaluate the elastic blade and the toner as to toner smear. FIG. 4 shows the measurement results.

Alternatively, when a contact-charge unit is not available, toner smear can be similarly judged by making a nonwoven cloth contact with the photoconductor surface and pressing the charge roller surface with the nonwoven cloth in the longitudinal direction of the photoconductor.

[Evaluation Result]

An image was formed using the elastic blade of the present invention in combination with the toner of the present invention under respective conditions. Table 1 shows the results of Examples 1 to 5 and Comparative Examples 1 to 3.

The elastic blade and the toner of the present invention were used under conditions shown in Table 1 in a printer machine of which IPSIO CX3000 manufactured by Ricoh Company Ltd. was remodeled. After 5,000 sheets of a 5% image-area ratio chart were consecutively output, and the photoconductor surface was cleaned. The toner adhesion on the photoconductor surface after the cleaning was observed using a CCD microscope camera (HYPER MICROSCOPE manufactured by KEYENCE CORPORATION) to thereby evaluate the toner and the elastic blade as to the cleaning defect that the toner passed through the cleaning blade at the point of cleaning the photoconductor surface.

TABLE 1

| | Toner | | | | | | | | | |
|---|---|---|---|---|---|---|---|---|---|---|
| | Average particle | | | | Cleaning Condition | | | | | |
| | diameter of external | | | | Rebound | | | | | |
| | additive | | | Amount of | elasticity | | | | Number of | |
| | Hydrophobic | Hydrophobic | | wax on | modulus | Static | Blade | | vibrations | |
| | silica A | silica B | Average | toner | of elastic | friction | thickness | Cleaning | at blade | Blade |
| | (nm) | (nm) | circularity | surface | blade (%) | coefficient | (mm) | defect | edge (Hz) | noise |
| Ex. 1 | 12 | 60 | 0.880 | 0.127 | 35 | 0.5 | 2 | A | 3.5 | A |
| Ex. 2 | 5 | 60 | 0.880 | 0.127 | 35 | 0.5 | 2 | A | 3 | A |
| Ex. 3 | 30 | 60 | 0.880 | 0.127 | 35 | 0.5 | 2 | A | 3.2 | A |
| Ex. 4 | 12 | 80 | 0.880 | 0.127 | 35 | 0.5 | 2 | A | 2.8 | A |
| Ex. 5 | 12 | 60 | 0.935 | 0.127 | 35 | 0.5 | 2 | A | 2.3 | A |
| Compara. | 12 | 40 | 0.880 | 0.127 | 35 | 0.5 | 2 | B | 4.2 | A |
| Ex. 1 | | | | | | | | | | |
| Compara. | 12 | 60 | 0.870 | 0.127 | 35 | 0.5 | 2 | B | 4.5 | A |
| Ex. 2 | | | | | | | | | | |
| Compara. | 12 | 60 | 0.940 | 0.127 | 35 | 0.5 | 2 | B | 1.5 | A |
| Ex. 3 | | | | | | | | | | |
| Compara. | 12 | 60 | 0.880 | 0.127 | 35 | 0.5 | 1.3 | B | 3.2 | A |
| Ex. 4 | | | | | | | | | | |
| Compara. | 12 | 60 | 0.880 | 0.127 | 35 | 0.5 | 2.8 | A | 3.8 | B |
| Ex. 5 | | | | | | | | | | |

* Added amount of external additive
Hydrophobic silica A: 1.0 parts by weight relative to 100 parts by weight of the toner
Hydrophobic silica B: 1.0 parts by weight relative to 100 parts by weight of the toner

As clearly demonstrated from the results of Examples 1 to 5 shown in Table 1, the respective elastic blades made it possible to obtain favorable results of both responsiveness and toner scraping-out effect and to reduce toner adhesive force and an amount of a residual toner remaining on the photoconductor in image formation using a toner which contains at least a releasing agent in toner particles and at least two or more external additives of a first external additive composed of a hydrophobic silica having an average particle diameter of 5 nm to 30 nm and a second external additive composed of a hydrophobic silica having an average particle diameter of 60 nm to 300 nm, and has an average circularity of 0.880 to 0.935; the rebound elasticity modulus of an elastic material used for the elastic blade making contact with the image bearing member is 35% or more under the condition of 25° C., and the number of vibrations at the blade edge is 2.0 kHz to 4.0 khz.e.

Hereinabove, while the present invention has been described with reference to the preferred embodiments, it is to be understood that the present invention is not limited to the disclosed aspects. On the contrary, the present invention is intended to cover various modifications and equivalent configurations included within the spirit and scope of the appended claims.

What is claimed is:

1. A cleaning device, comprising:
an elastic blade configured to make contact with an image bearing member to remove a toner remaining on the surface of an image bearing member,
wherein the toner comprises at least a releasing agent in toner particles and at least two or more external additives of a first external additive composed of a hydrophobic silica having an average particle diameter of 5 nm to 30 nm and a second external additive composed of a hydrophobic silica having an average particle diameter of 60 nm to 300 nm, and has an average circularity of 0.880 to 0.935;
the rebound elasticity modulus of an elastic material used for the elastic blade making contact with the image bearing member is 35% or more under the condition of 25° C., and the number of vibrations at the blade edge is 2.0 kHz to 4.0 kHz.

2. The cleaning device according to claim 1, wherein the static friction coefficient of the image bearing member is 0.5 to 1.0.

3. The cleaning device according to claim 1, wherein the elastic material used for the elastic blade has a shore A hardness of 60 to 80.

4. The cleaning device according to claim 1, wherein the contact angle formed when the elastic blade makes contact with the image bearing member is 7° to 20°.

5. The cleaning device according to claim 1, wherein the elastic blade is composed of a plate-like elastic material, and the thickness of the plate-like elastic material is 1.5 mm to 2.5 mm.

6. The cleaning device according to claim 1, wherein the added amount of the releasing agent in the toner is 2 parts by mass to 8 parts by mass relative to 100 parts by mass of the toner.

7. The cleaning device according to claim 1, wherein the exposed amount of the releasing agent on the surface of the base material in the toner determined by FTIR-ATR spectroscopy is 0.05 to 0.2.

8. An image forming apparatus, comprising:
a cleaning device equipped with an elastic blade configured to make contact with an image bearing member to remove a toner remaining on the surface of an image bearing member,
wherein the toner comprises at least a releasing agent in toner particles and at least two or more external additives of a first external additive composed of a hydrophobic silica having an average particle diameter of 5 nm to 30 nm and a second external additive composed of a hydrophobic silica having an average particle diameter of 60 nm to 300 nm, and has an average circularity of 0.880 to 0.935; the rebound elasticity modulus of an elastic material used for the elastic blade making contact with the image bearing member is 35% or more under the condition of 25° C., and the number of vibrations at the blade edge is 2.0 kHz to 4.0 kHz.

9. The image forming apparatus according to claim 8, wherein the static friction coefficient of the image bearing member is 0.5 to 1.0.

10. The image forming apparatus according to claim 8, wherein the elastic material used for the elastic blade has a shore A hardness of 60 to 80.

11. The image forming apparatus according to claim 8, wherein the contact angle formed when the elastic blade makes contact with the image bearing member is 7° to 20°.

12. The image forming apparatus according to claim 8, wherein the elastic material used for the elastic blade is formed in a plate-like shape, and the thickness of the plate-like elastic material is 1.5 mm to 2.5 mm.

13. The image forming apparatus according to claim 8, wherein the added amount of the releasing agent in the toner is 2 parts by mass to 8 parts by mass relative to 100 parts by mass of the toner.

14. The image forming apparatus according to claim 8, wherein the exposed amount of the releasing agent on the surface of the base material in the toner determined by FTIR-ATR spectroscopy is 0.05 to 0.2.
